(19) United States
(12) Patent Application Publication
(10) Pub. No.: US 2026/0141354 A1
(43) Pub. Date: May 21, 2026

(54) SPARE-PART QUANTITY FORECASTING SYSTEM FOR SERVER REPAIR BASED ON MULTIPLE-TIME-SERIES MODEL AND METHOD THEREOF

(71) Applicants: SQ Technology (Shanghai) Corporation, Shaighai (CN); Inventec Corporation, Taipei City (TW)

(72) Inventor: Xue-Da Sun, Shanghai (CN)

(21) Appl. No.: 19/024,813

(22) Filed: Jan. 16, 2025

(30) Foreign Application Priority Data
Nov. 21, 2024 (CN) 20241 16787237

(51) Int. Cl. G06Q 10/20; G06N 3/045; G06Q 10/04

(52) U.S. Cl. CPC G06Q 10/20; G06N 3/045; G06Q 10/04

(57) ABSTRACT

A spare-part quantity forecasting system for server repair based on multiple-time-series model and a method thereof are disclosed. In the system, a data exploration is executed with history experience data to establish a feature differentiation rule for an original feature of history time-series data, and the original feature is split into differentiated features based on the feature differentiation rule. A validity of the differentiated features is verified and the response of the differentiated features for the change of the target variable is evaluated until a preset result is met. A target variable is split into split target variables corresponding to the differentiated features, and the split target variables are used as training data inputted to a multiple-time-series model for training. To forecast the spare-part quantity, current time-series data is inputted to the trained multiple-time-series model, to obtain an accurate spare-part quantity forecasting result.

### CROSS-REFERENCE TO RELATED APPLICATION

This application claims the benefit of Chinese Application Serial No. 2024116787237, filed Nov. 21, 2024, which is hereby incorporated herein by reference in its entirety.

### BACKGROUND OF THE INVENTION

### 1. Field of the Invention

The present invention relates to a forecasting system and a method thereof, and more particularly to a spare-part quantity forecasting system for server repair based on multiple-time-series model and a method thereof.

### 2. Description of the Related Art

In recent years, with the widespread adoption and rapid development of servers, the demand for after-sales service has surged, especially replacing server components is the primary demand for after-sales maintenance. Therefore, how to prepare a reasonable spare-part quantity of server components has become one of the urgent problems for manufacturers to solve.

Generally, server components are typically stored in warehouses to be used for replacement when servers are repaired. Thus, the spare-part quantity of server components in the warehouse is a critical metric. Preparing a reasonable spare-part quantity of server components can better serve customers with after-sales service needs and save storage costs to a certain extent. However, server components often come in diverse varieties and have a long warranty time, so it is very difficult for server manufacturers to prepare spare parts, thus leading to the problem of being unable to accurately evaluate the spare-part quantity of servers.

To solve this problem, some manufacturers have proposed forecasting solution using time-series models, but this solution often has some limitations, for example, in insufficient data and using single model only. For example, regarding the limitation with insufficient data, existing analyses often rely on single history time-series data and some associated features. Regarding the limitation in using single model, existing forecasting analyses often use either a single model or multiple models to forecast the same target variable to obtain a final forecasting result through voting or weighting. Thus, these existing methods is still unable to effectively solve the problem of failing to accurately evaluate the spare-part quantity for servers.

According to above-mentioned contents, what is needed is to develop an improved solution to solve the conventional problem of failing to accurately evaluate the spare-part quantity for servers.

### SUMMARY OF THE INVENTION

An objective of the present invention is to disclose a spare-part quantity forecasting system for server repair based on multiple-time-series model and a method thereof.

To achieve the objective, the present invention discloses a spare-part quantity forecasting system for server repair based on multiple-time-series model, the system includes a feature differentiation module, an evaluating module, an adjusting module, a variable splitting module, a training module and a forecasting module. The feature differentiation module is configured to execute a data exploration with history experience data on an original feature of the history time-series data to generate a feature differentiation rule, and split the original feature to form differentiated features through the feature differentiation rule. The evaluating module is configured to verify validity of the differentiated features through at least one of a statistical method and a machine learning model, and evaluate a response of the differentiated features for a change of a target variable to generate an evaluation result. The adjusting module is configured to transmit the generated evaluation result to the data exploration and make the feature differentiation module and the evaluating module repeat executing to adjust the feature differentiation rule to re-form the differentiated features until the evaluation result meets a preset result. The variable splitting module is configured to split the target variable into N target sub-variables to correspond the differentiated features, respectively, wherein N is a positive integer and equal to a quantity of the differentiated features formed finally. The training module is configured to store a multiple-time-series model having time-series models, and use the target sub-variables and the corresponding differentiated features as training data, and input the training data to the time-series models of the multiple-time-series model for training until the multiple-time-series model is trained completely. While forecasting a spare-part quantity, the forecasting module receives current time-series data, inputs the current time-series data to the multiple-time-series model which is pre-trained, makes the time-series models of the multiple-time-series model output forecasting results, makes the multiple-time-series model integrate the forecasting results as a spare-part quantity forecasting result, and stores the current time-series data as the history time-series data.

The present invention discloses a spare-part quantity forecasting method for server repair based on multiple-time-series model, include steps of: performing a data exploration with history experience data on an original feature of history time-series data to generate a feature differentiation rule, and splitting the original feature to form differentiated features through the feature differentiation rule; verifying validity of the differentiated features through at least one of a statistical method and a machine learning model, and evaluating a response of the differentiated features for a change of a target variable to generate an evaluation result; transmitting the generated evaluation result to the data exploration, and repeating the above-mentioned steps to adjust the feature differentiation rule to re-form the differentiated features until the evaluation result meets a preset result; splitting the target variable into N target sub-variables to correspond the differentiated features, respectively, wherein N is a positive integer and equal to a quantity of the differentiated features formed finally; using the target sub-variables and corresponding differentiated features as training data, inputting the training data to different one of the time-series models of the multiple-time-series model for training until the multiple-time-series model is trained completely; to forecast a spare-part quantity, receiving current time-series data, inputting the current time-series data to the multiple-time-series model which is pre-trained, making each of time-series models of the multiple-time-series model output a forecasting result, making the multiple-time-series model integrate the forecasting results as a spare-part quantity forecasting result, and storing the current time-series data as the history time-series data.

According to the above-mentioned system and method of the present invention, the difference between the present invention and the conventional technology is that, in the present invention, the data exploration is executed with the history experience data to establish the feature differentiation rule for the original feature of history time-series data, and the original feature is split into differentiated features based on the feature differentiation rule; the validity of the differentiated features is verified and the response of the differentiated features for the change of the target variable is evaluated until the preset result is met; the target variable is split to make the quantity of the split target variables the same as that of the differentiated features and the split target variables correspond to the differentiated features, and the split target variables are used as training data inputted to the multiple-time-series model for training; when the spare-part quantity is forecasted, the current time-series data is received and inputted to the multiple-time-series model trained completely, to obtain the accurate spare-part quantity forecasting result.

Therefore, the above-mentioned solution of the present invention can achieve the technical effect of improving the evaluation accuracy of the spare-part quantity for servers.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a spare-part quantity forecasting system for server repair based on multiple-time-series model, according to the present invention.

FIG. 2A and FIG. 2B are flowcharts of a spare-part quantity forecasting method for server repair based on multiple-time-series model, according to the present invention.

FIG. 3A and FIG. 3B are schematic views of an operation of generating differentiated feature, according to an application of the present invention.

FIG. 4 is a schematic view of an operation of using a multiple-time-series model to forecast, according to an application of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first,’ ‘second,’ ‘third,’ and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on”, “connected to” or “coupled to” another element or layer, it can be directly on, connected or coupled to the other element or layer, or intervening elements or layers may be present. In contrast, when an element is referred to as being “directly on”, “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

The terms mentioned in the present invention are explained first. The original features described in the present invention refer to various statistical items and their values in history time-series data, such as a quantity of server components under warranty (referred to as in-warranty quantity). The differentiated feature is a feature extracted from the original feature based on a feature differentiation rule, for example, when the feature differentiation rule is splitting based on a warranty time, the differentiated feature can be split into different business stages, such as the in-warranty quantity in dead-on-arrival (DOA) stage, normal stage, and end-of-support (EOS) stage. The target variable refers to the variable that the model aims to forecast or explain; since time-series data is used in the system, the target variable is a value that changes over time, such as a quantity of failures, or a sales volume. After the data is differentiated, the differentiated data can be used as training data for different time-series models, respectively, so that the trained time-series models can output respective forecasting results, which are then integrated to form a spare-part quantity forecasting result.

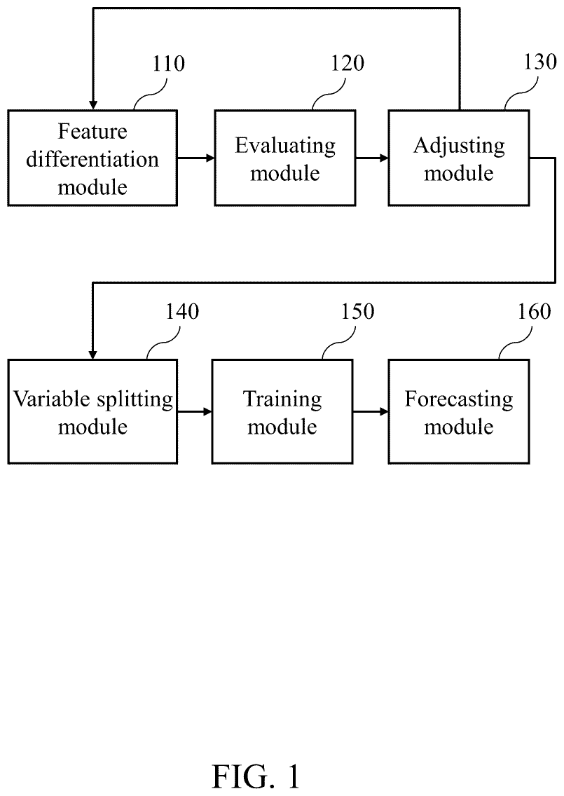

Please refer to FIG. 1. FIG. 1 is a block diagram of a spare-part quantity forecasting system for server repair based on multiple-time-series model, according to the present invention. The spare-part quantity forecasting system includes a feature differentiation module 110, an evaluating module 120, an adjusting module 130, a variable splitting module 140, a training module 150, and a forecasting module 160. The feature differentiation module 110 is configured to perform a data exploration with history experience data (such as expert experience) on an original feature of history time-series data to generate a feature differentiation rule, and then split the original feature to form one or more differentiated features based on the feature differentiation rule. In practical implementation, the history time-series data is pre-stored in a database and includes at least one of historical maintenance data, warranty data, shipment data, operation data, or production planning data for servers. In practice, the history time-series data refers to time series data, stored in a structured document format (such as JSON or XML) in chronological order, and the historical data related to server components (such as spare parts). The data exploration includes statistical analysis, sample distribution analysis, or data quality check. The feature differentiation rule can include at least one of period, category and specific rule such as warranty time.

The evaluating module 120 is configured to verify validity of the differentiated features through at least one of a statistical method and a machine learning model and evaluate responses of the differentiated features for a change of target variable to generate an evaluation result. In practical implementation, the validity verification for the differentiated features can be implemented through factor analysis, correlation analysis, or similar methods. The evaluation result can include at least one of mean square error, mean absolute error and R square.

The adjusting module 130 is configured to transmit the generated evaluation result back to the data exploration and make the feature differentiation module 110 and the evaluating module 120 repeat executing to adjust the feature differentiation rule, thereby re-forming the differentiated feature until the evaluation result meets a preset result. In other words, before an expected value is reached, the adjusting module 130 continuously transmitted back the generated evaluation result so that corresponding adjustments can be made based on the evaluation result during the execution of data exploration, thereby ensuring that the re-generated evaluation result meets the expected value, which is a forecasting result.

The variable splitting module 140 is configured to split the target variable into N target sub-variables, which correspond to different differentiated features respectively; wherein N is a positive integer and equal to a quantity of the differentiated features formed finally. For example, when the target variable is the quantity of server component failures and the quantity of final differentiated features is 3, the variable splitting module 140 splits the target variable into 3 target sub-variables to represent the quantity of failures in different business stages, such as DOA, normal, and EOS stages).

The training module 150 is configured to store a multiple-time-series model, which includes time-series models, use the target sub-variables and corresponding differentiated features as training data, input the training data to the different time-series models of the multiple-time-series model for training until the multiple-time-series model is trained completely. In practical implementation, the time-series models can include, for example, an autoregressive integrated moving average (ARIMA) model, a vector autoregression model, a vector error correction model, and a long short-term memory model, a deep learning model, or a generalized additive model.

To forecast the spare-part quantity, the forecasting module 160 receives and inputs current time-series data to the multiple-time-series model which is pre-trained, each of the time-series models of the multiple-time-series model outputs a forecasting result, the multiple-time-series model integrates the forecasting results as a spare-part quantity forecasting result, and the current time-series data is stored as the history time-series data. In practical implementation, after the current time-series data is stored as the history time-series data, the feature differentiation module 110 to the training module 150 can repeat executing to re-train the multiple-time-series model, to ensure that the multiple-time-series model is consistently trained with the most recent data. Additionally, using different the differentiated feature and selecting different time-series model for training are permitted, for example, for newly launched components having limited time-series data for the history time-series data, using a more complex LSTM model may led to overfitting issues; thus, a less complex ARIMA model can be selected for training to forecast, in other words, appropriate model selection can be selected based on the type of time-series data. Furthermore, the change of the target variable includes a correlation, and a change of a model effect improvement rate under the same time-series model, when the correlation and the model effect improvement rate become higher, the generated evaluation result increasingly meets the preset result, for example, the preset result can include the correlation being higher than 0.4 and the model effect improvement rate being higher than 20%. The correlation is determined through methods such as Pearson correlation coefficient, Spearman rank correlation coefficient, and chi-square tests. The model effect improvement rate can be calculated based on the accuracy comparison between new and old models, or other methods (such as mean square error, mean absolute error, R square, cross-validation, comparative testing, or confusion matrices) can be used to measure the model effect improvement rates.

It is to be particularly noted that, in actual implementation, the above-mentioned modules of the present invention can be implemented fully or partly based on hardware, for example, the hardware processor can be implemented by integrated circuit chip, system on chip (SoC), a complex programmable logic device (CPLD), or a field programmable gate array (FPGA). The data mentioned in the present invention can be stored in a non-transitory computer-readable storage medium, and the non-transitory computer-readable storage medium can record computer readable program instructions, and the hardware processor can execute the computer readable program instructions to implement concepts of the present invention. The non-transitory computer-readable storage medium can be a tangible apparatus for holding and storing the instructions executable of an instruction executing apparatus. The non-transitory computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the non-transitory computer-readable storage medium can include a hard disk, an RAM memory, a read-only-memory, a flash memory, an optical disk, a floppy disc, or any appropriate combination thereof, but this exemplary list is not an exhaustive list. The non-transitory computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the non-transitory computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network and forward the computer readable program instruction to store in non-transitory computer-readable storage medium of each calculating/processing apparatus. In actual implementation, the present invention can be implemented in environment where a computer host is connected to a database. The computer host can include a non-transitory computer-readable storage medium and a hardware processor. The non-transitory computer-readable storage medium stores computer readable program instructions, and multiple-time-series model having time-series models. The computer host can execute the computer readable program instructions. The computer readable program instructions can be assembly language instructions, instruction-set-structure instructions, machine instructions, machine-related Instructions, micro-instructions, firmware instructions, or source codes or object codes written in any combination of one or more programming languages. The programming language includes object-oriented programming languages, such as: Common Lisp, Python, C++, Objective-C, Smalltalk, Delphi, Java, Swift, C#, Perl, Ruby, or PHP; the programming language can include regular procedural programming languages, such as C language or similar programming languages. The hardware processor is electrically connected to the non-transitory computer-readable storage medium and configured to execute the computer readable program instructions.

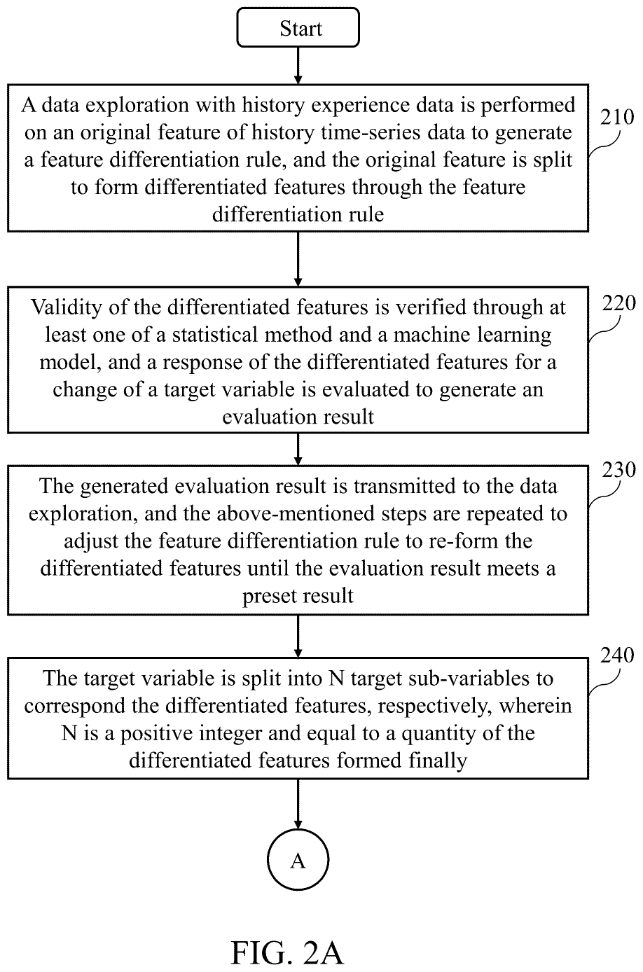

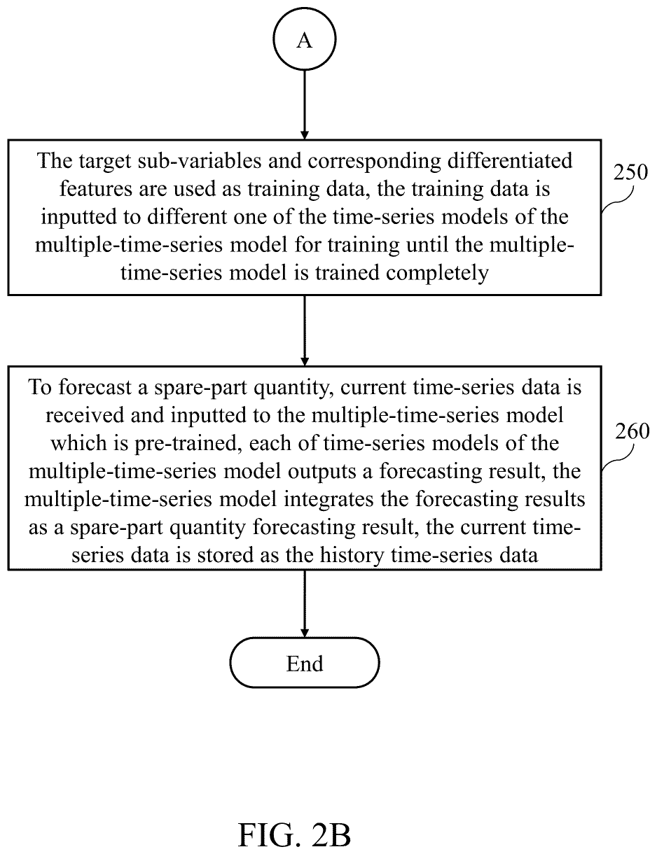

Please refer to FIG. 2A and FIG. 2B. FIG. 2A and FIG. 2B are flowcharts of a spare-part quantity forecasting method for server repair based on multiple-time-series model, according to the present invention. The spare-part quantity forecasting method includes the following steps. In a step 210, a data exploration with history experience data is performed on an original feature of history time-series data to generate a feature differentiation rule, and the original feature is split to form differentiated features through the feature differentiation rule. In a step 220, validity of the differentiated features is verified through at least one of a statistical method and a machine learning model, and a response of the differentiated features for a change of a target variable is evaluated to generate an evaluation result. In a step 230, the generated evaluation result is transmitted to the data exploration, and the above-mentioned steps are repeated to adjust the feature differentiation rule to re-form the differentiated features until the evaluation result meets a preset result. In a step 240, the target variable is split into N target sub-variables to correspond the differentiated features, respectively, wherein N is a positive integer and equal to a quantity of the differentiated features formed finally. In a step 250, the target sub-variables and corresponding differentiated features are used as training data, the training data is inputted to different one of the time-series models of the multiple-time-series model for training until the multiple-time-series model is trained completely. In a step 260, to forecast a spare-part quantity, current time-series data is received, the current time-series data is inputted to the multiple-time-series model which is pre-trained, each of time-series models of the multiple-time-series model outputs a forecasting result, the multiple-time-series model integrates the forecasting results as a spare-part quantity forecasting result, the current time-series data is stored as the history time-series data. Through aforementioned steps, the data exploration is executed with the history experience data to establish the feature differentiation rule for the original feature of history time-series data, and the original feature is split into differentiated features based on the feature differentiation rule; the validity of the differentiated features is verified and the response of the differentiated features for the change of the target variable is evaluated until the preset result is met; the target variable is split to make the quantity of the split target variables the same as that of the differentiated features and the split target variables correspond to the differentiated features, and the split target variables are used as training data inputted to the multiple-time-series model for training; when the spare-part quantity is forecasted, the current time-series data is received and inputted to the multiple-time-series model trained completely, to obtain the accurate spare-part quantity forecasting result.

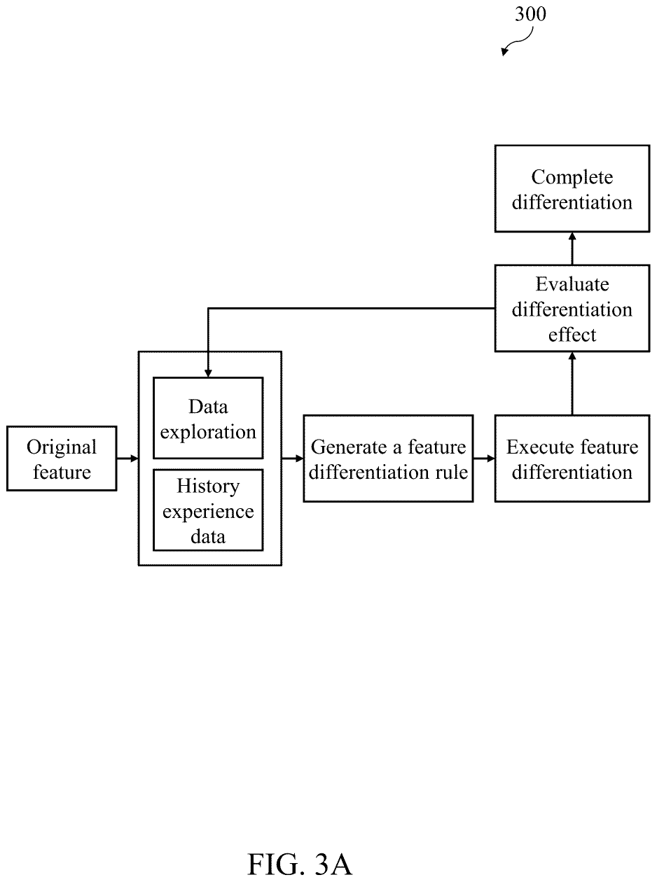

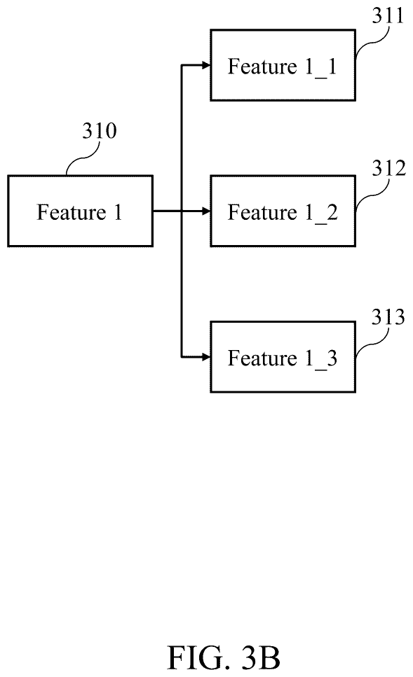

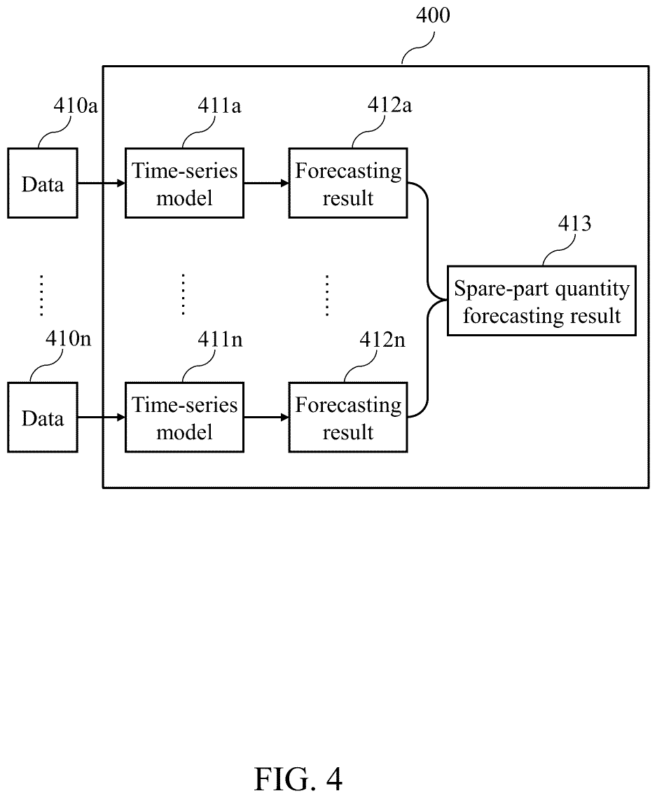

An embodiment of the present invention will be illustrated in the following paragraphs with reference to FIG. 3A, FIG. 3B, and FIG. 4. Please refer to FIG. 3A and FIG. 3B. FIG. 3A and FIG. 3B are schematic views of an operation of generating differentiated feature, according to an application of the present invention. The operation 300 of generating differentiated feature is completed by combining history experience data with a data exploration. The data exploration refers to a preliminary analysis of an original feature (such as a statistical analysis, a sample distribution analysis, or a data quality check) to explore a correlation between features (such as in-warranty quantities in different business stages) and target variables (such as failure quantity in different business stages). Additionally, the history experience data is used to assess the feasibility of differentiated features, so a feature differentiation rule can be generated based on the history experience data and the data exploration, for example, the feature differentiation rule can be differentiated (or split) by period, category, or specific rules (such as warranty time). In practice, the differentiating operation can be achieved using statistical methods such as discretization, partitioning, and clustering. Applying the feature differentiation rule to split the original feature into differentiated features can ensure that the differentiated feature have clear meanings. Next, the statistical method or models can be used to verify the validity of the differentiated features to assess whether the differentiated features can better respond the change in the target variable, for example, the verification can be performed based on a correlation and a model effect improvement rate under the same model. Subsequently, the feature differentiation rule is adjusted based on the feedback for an evaluation result, and after several iterations, when the evaluation result meet the preset result, the final feature differentiation rule and corresponding differentiated features are confirmed. It is to be noted that, natural dimensions of the target variable is usually applied to the differentiated feature, for example, the server repair issue is viewed from a time-series perspective, and the specific point in the warranty lifecycle when a repair occurs becomes an important consideration for differentiation. This allows for exploring specific differentiation approaches based on the distribution of repairs occurring at different warranty lifecycle points.

For example, to perform differentiation using a warranty time 310 (a feature 1), three differentiated features 311˜313 (as shown in FIG. 3B) can be generated for better fitting the data, the first differentiated feature 311 (a feature 1_1) corresponds to the DOA stage, the second differentiated feature 312 (a feature 1_2) corresponds to the normal stage, and the third differentiated feature 313 (a feature 1_3) corresponds to the EOS stage. The three differentiated features 311˜313 represent the in-warranty quantities of components at different stages. The original data for these features can be obtained by organizing warranty and shipment data.

Please refer to FIG. 4, which is a schematic view of an operation of using a multiple-time-series model to forecast, according to an application of the present invention. In practical implementation, a multiple-time-series model 400 of the present invention includes time-series models 411a˜411n, and a quantity of the time-series models 411a˜411n corresponds to the final quantity of differentiated features. After the multiple-time-series model 400 is trained, the computer host receives time-series data, such as data 410a˜410n, and inputs the time-series data into the multiple-time-series model 400 so that the time-series models 411a˜411n output corresponding forecasting results 412a˜412n, respectively. Subsequently, the multiple-time-series model 400 integrates the forecasting results 412a˜412n to form a spare-part quantity forecasting result 413. Compared with conventional methods relying on a single model or single history time-series data, the present invention uses the time-series models 411a˜411n with slightly different features to effectively improve the evaluation accuracy of using single model or fixed features. It is to be noted that each of the data 410a˜410n includes a target variable and features, and the features are not fixed theoretically. The features adopted in each of the data 410a˜410n are mainly determined by their contribution to the model. For example, in the time-series model (such as ARIMA, LSTM, prophet, etc.), different models and features can be selected based on the historical data and current change in the data. Through continuous data accumulation, model selection and feature selection can be re-evaluated and trained to ensure that the multiple-time-series model 400 can continuously forecast based on the latest data.

According to above-mentioned contents, the difference between the present invention and the conventional technology is that, in the present invention, the data exploration is executed with the history experience data to establish the feature differentiation rule for the original feature of history time-series data, and the original feature is split into differentiated features based on the feature differentiation rule; the validity of the differentiated features is verified and the response of the differentiated features for the change of the target variable is evaluated until the preset result is met; the target variable is split to make the quantity of the split target variables the same as that of the differentiated features and the split target variables correspond to the differentiated features, and the split target variables are used as training data inputted to the multiple-time-series model for training; when the spare-part quantity is forecasted, the current time-series data is received and inputted to the multiple-time-series model trained completely, to obtain the accurate spare-part quantity forecasting result.

Therefore, the above-mentioned solution of the present invention can solve the conventional problem and achieve the technical effect of improving the evaluation accuracy of the spare-part quantity for servers.

The present invention disclosed herein has been described by means of specific embodiments. However, numerous modifications, variations and enhancements can be made thereto by those skilled in the art without departing from the spirit and scope of the disclosure set forth in the claims.

1. A spare-part quantity forecasting system for server repair based on a multiple-time-series model, comprising:
a non-transitory computer-readable storage medium storing a plurality of instructions; and
a hardware processor communicatively coupled to the non-transitory computer-readable storage medium, wherein the hardware processor executes the plurality of instructions to:
execute a data exploration with history experience data on an original feature of history time-series data to generate a feature differentiation rule, and split the original feature to form a plurality of differentiated features through the feature differentiation rule;
verify validity of the plurality of differentiated features through at least one of a statistical method and a machine learning model, and evaluate a response of the plurality of differentiated features for a change of a target variable to generate an evaluation result;
an transmit the generated evaluation result to the data exploration and repeat executing the feature differentiation and the verifying validity to adjust the feature differentiation rule to re-form the plurality of differentiated features until the evaluation result meets a preset result;
split the target variable into N target sub-variables to correspond to the plurality of differentiated features, respectively, wherein N is a positive integer and equal to a quantity of the plurality of differentiated features formed finally;
store a multiple-time-series model having a plurality of time-series models, and use the N_target sub-variables and the corresponding plurality of differentiated features as training data, and input the training data to the plurality of time-series models of the multiple-time-series model for training until the multiple-time-series model is trained completely; and
receive current time-series data while a spare-part quantity is forecasted, input the current time-series data to the multiple-time-series model which is pre-trained, make the plurality of time-series models of the multiple-time-series model output forecasting results, make the multiple-time-series model integrate the forecasting results as a spare-part quantity forecasting result, and store the current time-series data as the history time-series data.

2. The spare-part quantity forecasting system for server repair based on multiple-time-series model according to claim 1, wherein the plurality of time-series models comprises an autoregressive integrated moving average (ARIMA) model, a vector autoregression model, a vector error correction model, a long short-term memory model, a deep learning model, or a generalized additive model.

3. The spare-part quantity forecasting system for server repair based on multiple-time-series model according to claim 1, wherein the evaluation result comprises at least one of a mean square error, a mean absolute error and an R square, the data exploration comprises a statistical analysis, a sample distribution analysis, and a data quality check, and the feature differentiation rule comprises at least one of a period, a category, and a specific rule.

4. The spare-part quantity forecasting system for server repair based on multiple-time-series model according to claim 1, wherein after the current time-series data is stored as the history time-series data, the hardware processor repeats executing the instructions for the feature differentiation, the verifying validity, the splitting the target variable, and the training to re-train the multiple-time-series model, and the hardware processor selects a different one of the plurality of differentiated features and selects a different one of the plurality of time-series models for training.

5. The spare-part quantity forecasting system for server repair based on multiple-time-series model according to claim 1, wherein the change of the target variable comprises a correlation and a change of a model effect improvement rate under the same time-series model, and when the correlation and the model effect improvement rate become higher, the generated evaluation result meets the preset result more.

6. A spare-part quantity forecasting method for server repair based on a multiple-time-series model, comprising:
performing a data exploration with history experience data on an original feature of history time-series data to generate a feature differentiation rule, and splitting the original feature to form a plurality of differentiated features through the feature differentiation rule;
verifying validity of the plurality of differentiated features through at least one of a statistical method and a machine learning model, and evaluating a response of the plurality of differentiated features for a change of a target variable to generate an evaluation result;
transmitting the generated evaluation result to the data exploration, and repeating the above-mentioned steps to adjust the feature differentiation rule to re-form the plurality of differentiated features until the evaluation result meets a preset result;
splitting the target variable into N target sub-variables to correspond to the plurality of differentiated features, respectively, wherein N is a positive integer and equal to a quantity of the plurality of differentiated features formed finally;
using the N target sub-variables and corresponding plurality of differentiated features as training data, inputting the training data to a plurality of time-series models of the multiple-time-series model for training until the multiple-time-series model is trained completely; and
to forecast a spare-part quantity, receiving current time-series data, inputting the current time-series data to the multiple-time-series model which is pre-trained, making each of the plurality of time-series models of the multiple-time-series model output a forecasting result, making the multiple-time-series model integrate the forecasting results as a spare-part quantity forecasting result, and storing the current time-series data as the history time-series data.

7. The spare-part quantity forecasting method for server repair based on multiple-time-series model according to claim 6, wherein the plurality of time-series models comprises an autoregressive integrated moving average (ARIMA) model, a vector autoregression model, a vector error correction model, a long short-term memory model, a deep learning model, or a generalized additive model.

8. The spare-part quantity forecasting method for server repair based on multiple-time-series model according to claim 6, wherein the evaluation result comprises at least one of a mean square error, a mean absolute error and an R square, the data exploration comprises a statistical analysis, a sample distribution analysis, and a data quality check, and the feature differentiation rule comprises at least one of a period, a category, and a specific rule.

9. The spare-part quantity forecasting method for server repair based on multiple-time-series model according to claim 6, after the step of storing the current time-series data as the history time-series data, further comprising:
repeating executing the performing the data exploration, the verifying validity, the splitting the target variable, and the using the target sub-variables to re-train the multiple-time-series model, and selecting a different one of the plurality of differentiated features and selecting a different one of the plurality of time-series models for training.

10. The spare-part quantity forecasting method for server repair based on multiple-time-series model according to claim 6, wherein the change of the target variable comprises a correlation and a change of a model effect improvement rate under the same time-series model, and when the correlation and the model effect improvement rate become higher, the generated evaluation result meets the preset result more.
